(19) United States
(12) Patent Application Publication
(10) Pub. No.: US 2023/0182109 A1
(43) Pub. Date: Jun. 15, 2023

(54) COMPOSITION

(71) Applicants: Vladimir BALAKAREV, Maykop (RU); Stepan BALAKAREV, Maykop (RU); Andrey KARPENKO, Belgorod region (RU); SKY EAST UK LTD, London (GB)

(72) Inventor: Vladimir BALAKAREV, Maykop (RU)

(21) Appl. No.: 17/926,397

(22) PCT Filed: May 21, 2021
(86) PCT No.: PCT/GB2021/051252

§ 371 Date: Nov. 18, 2022

(30) Foreign Application Priority Data
May 22, 2020 (RU) 2020116987

(51) Int. Cl. B01J 20/20; C05D 9/02; C05F 17/05; C05F 5/00; C05G 3/80; C09K 17/02; B01J 20/30

(52) U.S. Cl. CPC B01J 20/20; C05D 9/02; C05F 17/05; C05F 5/002; C05G 3/80; C09K 17/02; B01J 20/3078

(57) ABSTRACT

A composition comprising carbon and ash, wherein the composition comprises between 65 and 95% w/w carbon and between 2% and 25% w/w ash. There is also provided a method of producing the composition.

The present invention relates to a composition comprising carbon and ash and a method of preparing the composition.

Biochar is a carbon based compound that is produced by heating biomass in low or zero oxygen conditions to high temperatures which produces a soil charcoal-like enhancer or char, as well as energy rich gases and liquids. Biochar is typically produced by burning biomass from agricultural and forestry waste. Biochar is similar in appearance to charcoal, but the process used to produce biochar is carried out in a specific way in order to reduce contamination.

The process used to produce biochar is known as pyrolysis or carbonisation. During pyrolysis, organic materials such as wood chips are burned in a container with very little oxygen and the organic material is converted into biochar.

Biochar contains a high proportion of very stable carbon. The structure of biochar is largely amorphous but contains some local crystalline structure of highly conjugated aromatic compounds. The carbon atoms are strongly bound to one another, and it is this which makes them resistant to attack and decomposition by microorganisms (Downie, A., Crosky, A. and Munroe, P. (2009), Physical Properties of Biochar, Biochar for Environmental Management, Earthscan, London: 13-32).

Biochar is often used as a soil amendment to improve the quality of soil. Some of the ways that biochar can be used to improve soil quality are that it may increase water retention, decrease acidity, store carbon and reduce nitrous oxide emissions. The highly porous structure of biochar has the effect of increasing water retention, such that the biochar acts as a slow release sponge for water and other useful soil nutrients.

Biochar is typically made from trees. However, there is a desire to look for other methods of improving soil quality using other sources that are more environmentally friendly.

The present invention aims to address the above problems.

According to a first aspect, there is provided a composition comprising carbon and ash, wherein the composition comprises between 65 and 95% w/w carbon and between 2 and 25 w/w ash.

Advantageously, the high carbon concentration in the composition is beneficial for soil health and fertility of soil when the composition is applied to soil. Advantageously, a low concentration of ash is beneficial for soil fertility when the composition is applied to soil. Advantageously, the high concentration of carbon assists in carbon capture, carbon storage and/or carbon sequestration.

Preferably, the composition comprises between 66 and 80% w/w carbon and between 5 and 10% w/w ash.

Preferably, the composition further comprises between 2 and 2.5% w/w nitrogen. Advantageously, the provision of a composition comprising nitrogen is advantageous for soil fertility when the composition is applied to soil and assists in plant growth.

Advantageously, the provision of a composition comprising the carbon, ash and/or nitrogen concentrations of the invention improves carbon capture and storage within soil, thus reducing the emissions typically associated with fertiliser production.

Typically, the composition further comprises one or more nutrients selected from the group of phosphorous, potassium, magnesium, sulphur, copper, zinc, sodium and/or calcium. Advantageously, the provision of a composition comprising micro and macro elements in the form of nutrients is beneficial for soil health.

Typically, the composition comprises between 80 and 90% w/w organic matter. Typically, the organic matter comprises carbon, hydrogen and/or oxygen. In one embodiment, the organic matter may comprise one or more additional elements selected from the group of nitrogen, phosphorous, sulphur, potassium, calcium, copper, zinc, sodium and/or magnesium. In one embodiment, the organic matter may comprise fresh or decomposing plant matter, roots, fauna, microorganisms, and/or chemically resistant materials such as charcoal. Advantageously, the provision of a composition comprising a high concentration of organic matter may be beneficial when the composition is applied to soil, since the organic matter is advantageously beneficial for soil health and fertility.

In one embodiment, the composition comprises between 85 and 90% w/w organic matter.

Typically, the composition may comprise carbon, ash and/or one or more nutrients to improve the quality of soil, compost, growing media or organic based fertiliser.

According to a second aspect, there is provided a method of producing a composition according to the first aspect of the invention, wherein the method comprises the steps of:

loading a feedstock into a pyrolysis reactor;

heating the reactor to a temperature of between 80 and 750° C.;

carrying out a pyrolysis reaction within the reactor; and

extracting the composition from the reactor.

In one embodiment, the feedstock may be applied directly to a reactor. In another embodiment, the feedstock may be ground before being applied to the reactor. In one embodiment, the step of grinding the feedstock may comprise grinding the feedstock to form particles, wherein the particles typically have a diameter of 0.001 inch to 1 inch.

Typically, once the reactor has been heated to a temperature of between 80 and 750° C. the pyrolysis reaction starts and the burner stops. Typically, the pyrolysis reaction continues until it finishes naturally.

Typically, the reactor is designed such that the access of oxygen to the reactor is limited, but not totally excluded from the reactor. Advantageously, the limited presence of oxygen during the reaction optimises the production of the composition and reduces the production of contaminants during the process. Typically, the pyrolysis reaction occurs under anaerobic conditions.

Preferably, the pyrolysis reaction is used to burn off biomass with a limited presence of oxygen.

In one embodiment, the reaction occurs within a pressure range of 0.2 MPa to 10 GPa.

Preferably, the method takes place in a biochar kiln.

In one embodiment, the pyrolysis reaction may occur over a time period of between 1 and 5 hours.

Preferably, the feedstock is selected from the group consisting of pressed fruits and/or fruit pulp, vegetables, fruit stones, a by-product of whisky or beer, banana fruit, banana plants, coffee beans, plants, grass, leaves, herbs, olives, leaves, flowers, tea leaves and tea plants and/or solid digestate.

Typically, the solid digestate may comprise waste products from an anaerobic digestion process.

Typically, the pressed fruits and/or fruit pulp is obtained from apples, pears, grapes and/or berries.

In one embodiment, the fruit stones are obtained from nectarines, peaches, apricots, avocados and/or olives.

In one embodiment, the feedstock comprises the parts of the banana plant remaining once the banana fruit has been removed.

In one embodiment, the feedstock comprises draff, wherein the draff is the residue of husks after fermentation of the grain used in brewing.

In one embodiment, the feedstock may be a plant such as a sunflower plant.

Advantageously, the composition may be prepared from a feedstock comprising a waste product of food production. In this embodiment, the composition is advantageously easily available at a low cost and is more environmentally friendly.

According to a third aspect, there is provided a method of improving the quality of soil, compost, growing media or organic based fertiliser using a composition according to the first aspect. Advantageously, the use of the composition when applied to soil improves crop productivity.

In one embodiment, the composition is used as a soil fertility enhancer for agricultural and/or horticultural purposes.

In another embodiment, the composition is used as a soil fertility enhancer for vertical farming.

Advantageously, the use of the composition improves the fertility of the soil, extends the soil fertility and reduces the quantity of fertilisers that may be required.

In one embodiment, the composition may be used as a soil fertility enhancer for urban greening purposes, including green roofs and walls. Advantageously, the use of the composition improves the fertility of soils used for green roofs and walls, keeping the plants provided in the green roof or green wall alive with minimal effort.

In another embodiment, the composition is used as an active agent to clean soils from different contaminants, wherein the contaminants may include residues from herbicides and/or pesticides.

Preferably, the composition is used to enhance the properties of composts and similar growing media.

Preferably, the composition is used to enhance the properties of an organic fertiliser.

Typically, the fertiliser comprises worm castings or manure-based fertilisers. Advantageously, the use of the composition makes the soil more fertile and more productive over a longer period of time than soil that does not comprise the composition.

According to a fourth aspect, there is provided a method of pharmaceutical wastewater treatment using a composition according to the first aspect of the invention. Typically, the composition has a porous structure. Advantageously, the composition adsorbs contaminants from wastewater.

According to a fifth aspect, there is provided a method of carbon dioxide capture using a composition according to the first aspect of the invention. Typically, the composition may further be used in carbon storage and/or carbon sequestration.

According to a sixth aspect, there is provided a method of preparing a substrate, wherein the substrate comprises a composition according to the first aspect.

In one embodiment, the method comprises the step of adding at least one of a fertiliser and/or an organic fulfilment material to the substrate. Preferably, the fertiliser comprises worm casts. Preferably, the organic fulfilment material comprises coconut wool.

According to a seventh aspect, there is provided a substrate comprising a composition according to the first aspect.

In one embodiment, the substrate further comprises at least one of a fertiliser and/or an organic fulfilment material. Preferably, the fertiliser comprises worm casts or manure. Preferably, the organic fulfilment material comprises coconut wool.

Preferably, the substrate is used in the treatment of fungus related diseases of the soil.

In one embodiment, the substrate is a living substrate.

The invention will now be described by way of example and with reference to the following figures, wherein:

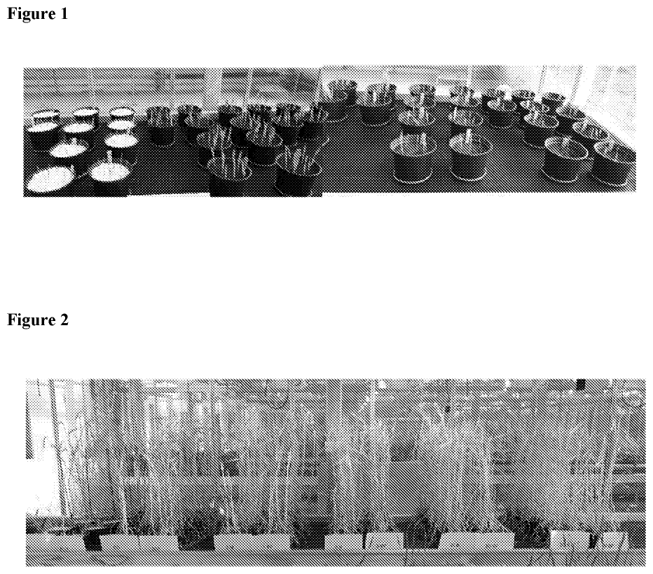

FIG. 1 shows the results of experiments illustrating spring barley seedling emergence (7 days after sowing);

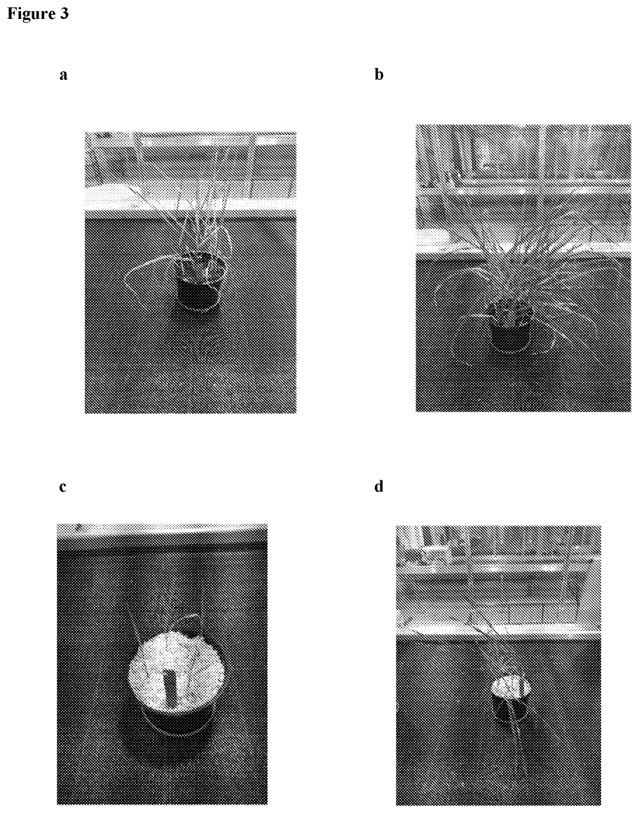

FIG. 2 shows an example of mature spring barley plants (132 days after sowing) before harvest;

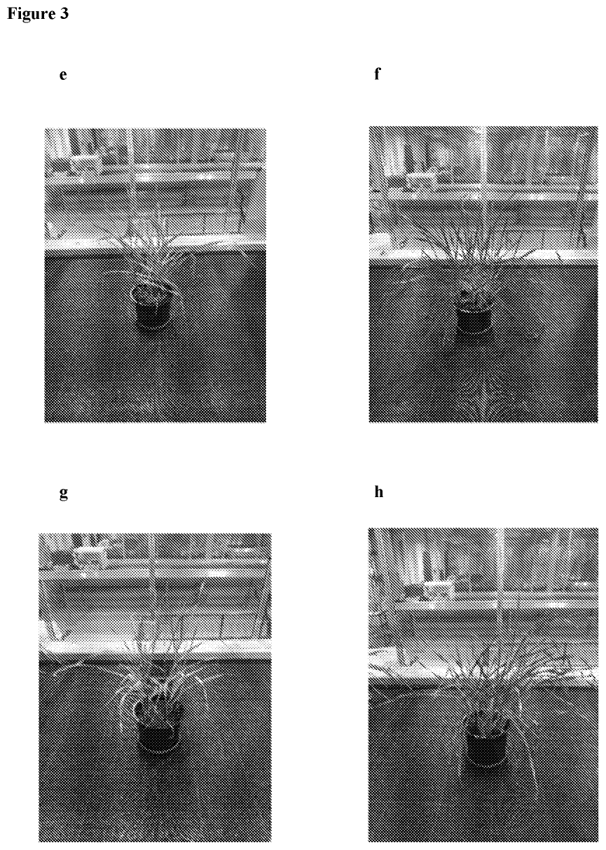

FIGS. 3a to 3j show the effect of various treatments on plants after 40 days growth;

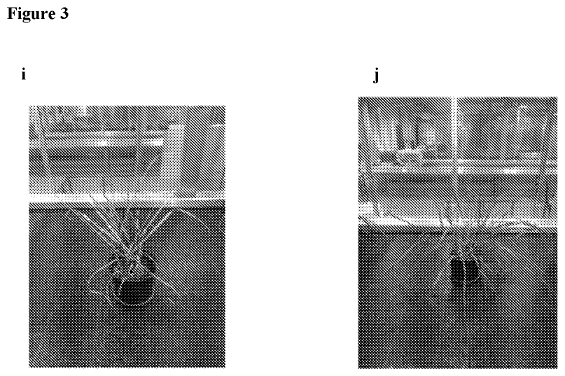

FIGS. 4a to 4f show the effect of various treatments on plants after 132 days growth;

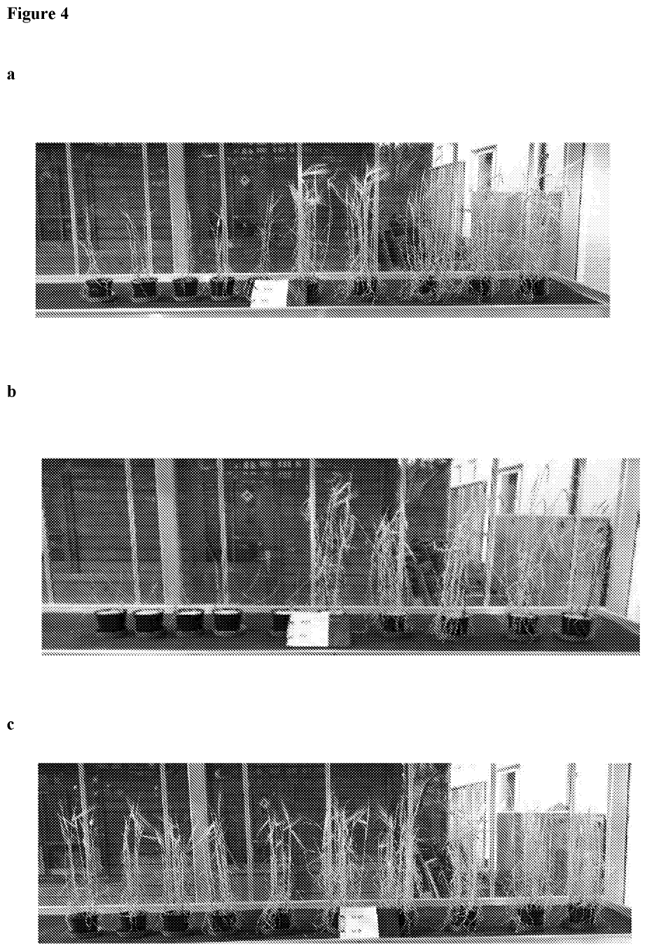

FIG. 5 shows the results of experiments showing barley above ground biomass;

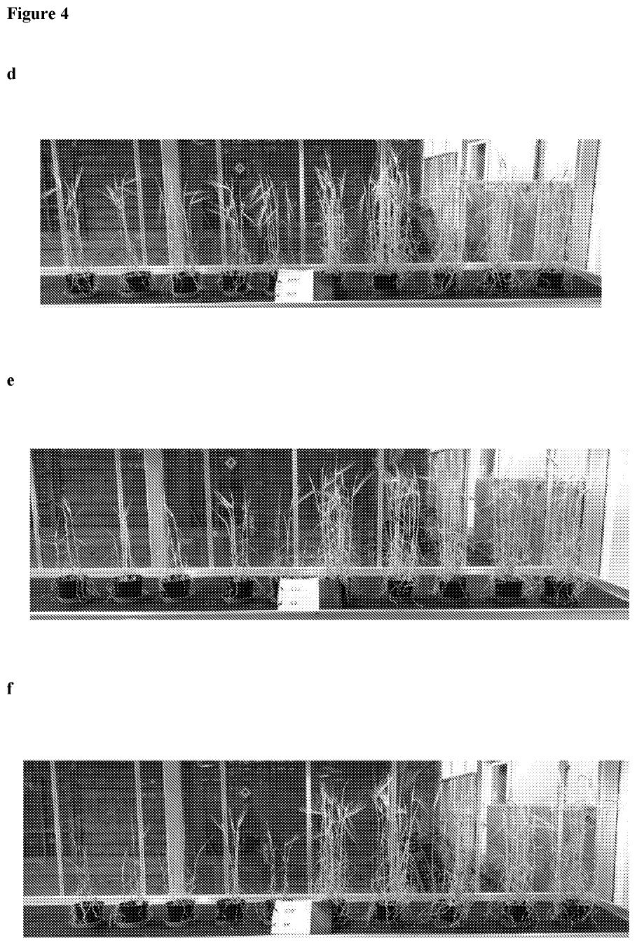

FIG. 6 shows the results of experiments showing barley below ground biomass;

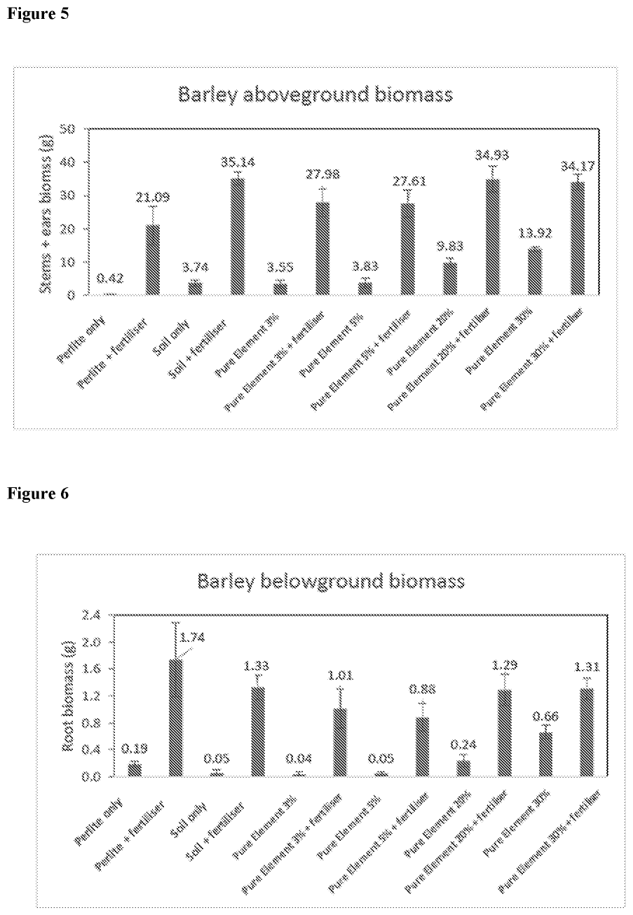

FIG. 7a shows the results of experiments showing barley stem carbon contents;

FIG. 7b shows the results of experiments showing barley stem nitrogen contents;

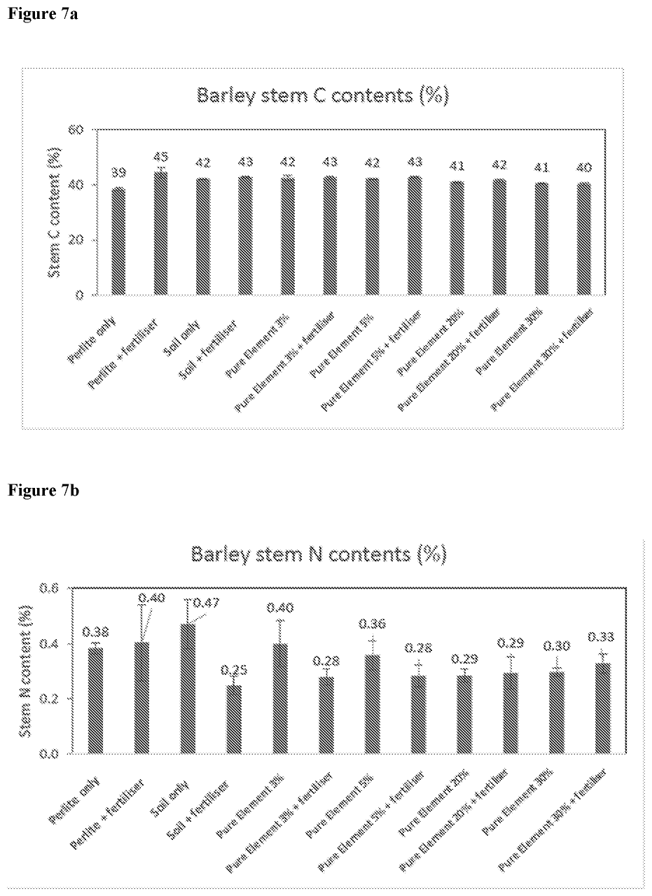

FIG. 8a shows the results of experiments showing barley grain carbon contents;

FIG. 8b shows the results of experiments showing barley grain nitrogen contents;

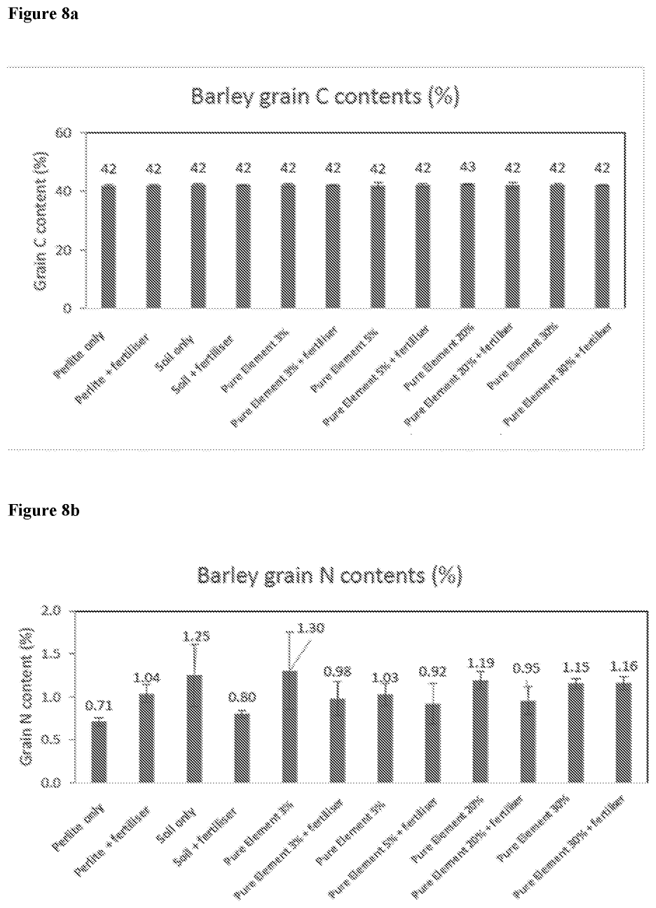

FIG. 9a shows the results of experiments showing barley root carbon contents;

FIG. 9b shows the results of experiments showing barley root nitrogen contents;

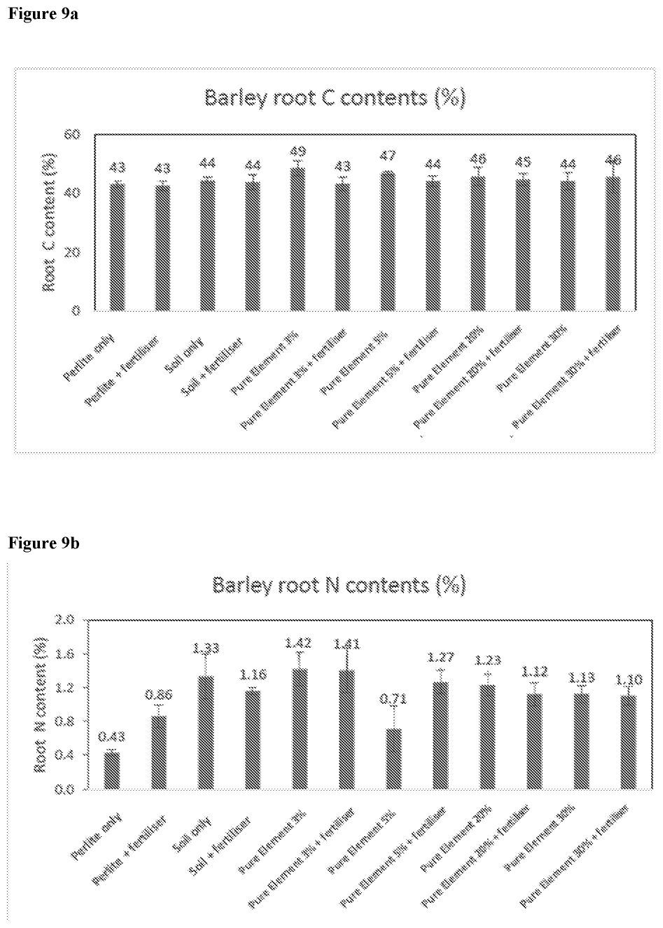

FIG. 10a shows the results of experiments showing growth medium mean pH value (post-harvest);

FIG. 10b shows the results of experiments showing growth medium electrical conductivity (post-harvest);

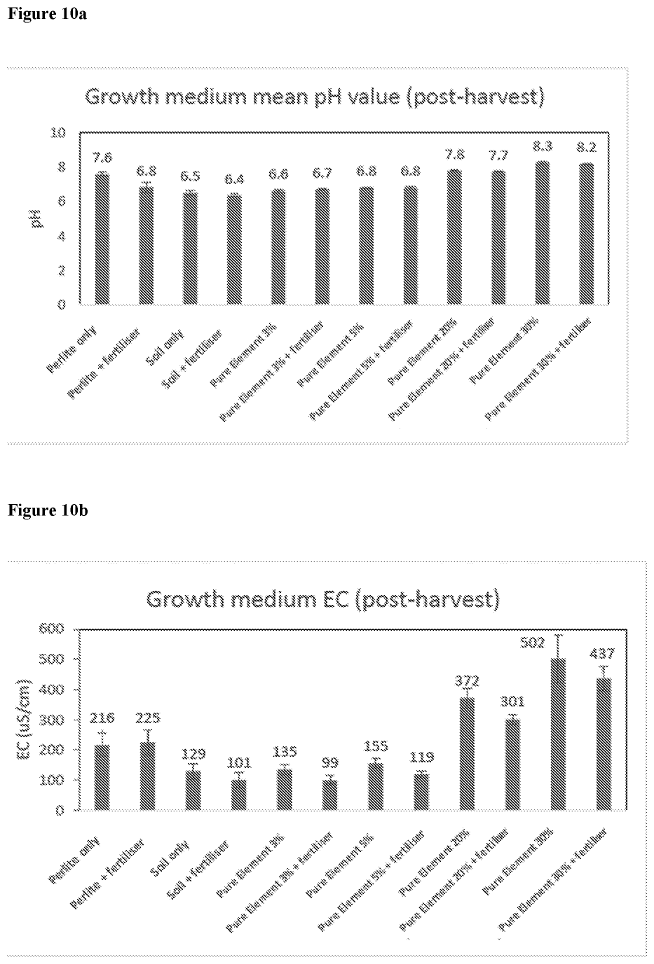

FIG. 11a shows the results of experiments showing growth medium ammonium-N contents (post-harvest);

FIG. 11b shows the results of experiments showing growth medium nitrate and nitrite-N contents (post-harvest);

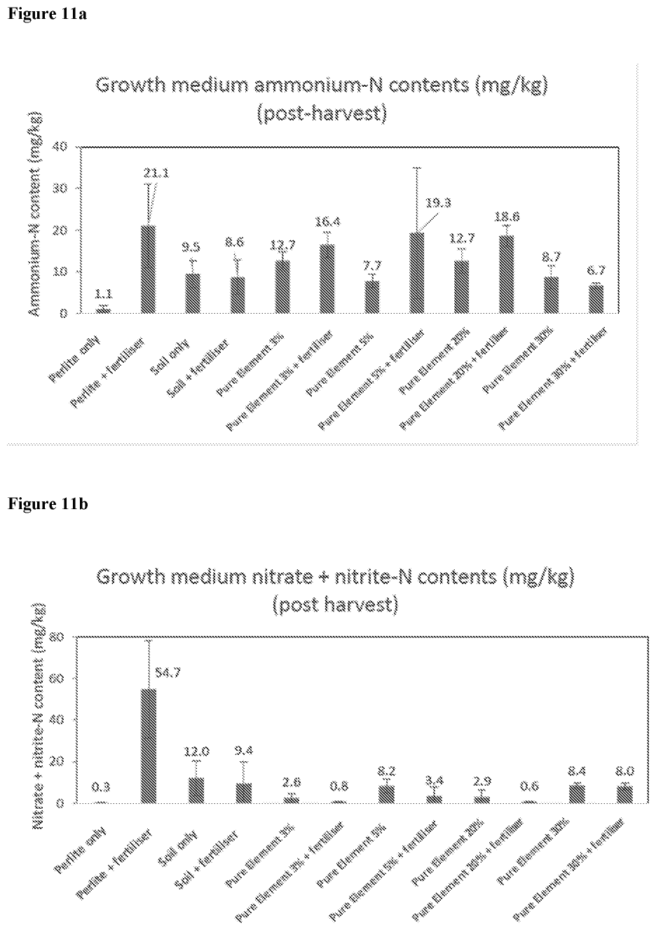

FIGS. 12, 13 and 14 show the isotherms measured in respect of the samples of the composition in accordance with an embodiment of the invention;

With reference to the figures, there is provided a composition comprising carbon and ash, wherein the composition comprises between 65 and 95% w/w carbon and between 2 and 25 w/w ash.

Advantageously, the presence of a high concentration of carbon is beneficial when the composition is applied to soil, since the high carbon concentration is beneficial for soil health and fertility of soil. In addition, the presence of a high concentration of carbon is beneficial for CO₂ capture and/or storage.

The composition may further comprise between 2 and 2.5% w/w nitrogen.

Advantageously, the provision of a composition comprising the carbon, ash and/or nitrogen concentrations of the invention improves carbon capture and storage, thus reducing the emissions typically associated with fertiliser production.

The composition may further comprise one or more nutrients selected from the group of phosphorous, potassium, magnesium, sulphur, copper, zinc, sodium and/or calcium. Advantageously, the provision of a composition comprising micro and macro elements in the form of nutrients is beneficial for soil health.

Typically, the composition comprises between 80 and 90% w/w organic matter. Advantageously, the provision of a composition comprising a high concentration of organic matter may be beneficial when the composition is applied to soil, since the organic matter is advantageously beneficial for soil health and fertility.

Advantageously, the composition may comprise carbon, ash and one or more nutrients to improve the quality of soil, compost, growing media or organic based fertiliser.

With reference to the figures, there is also provided a method of producing a composition according to the invention, wherein the method comprises the steps of:

loading a feedstock into a pyrolysis reactor;

heating the reactor to a temperature of between 80 and 750° C.;

carrying out a pyrolysis reaction within the reactor; and

extracting the composition from the reactor.

The feedstock may be applied directly to a reactor. In another embodiment, the feedstock may be ground before being applied to the reaction. In one embodiment, the step of grinding the feedstock comprises grinding to produce particles having a diameter of 0.001 inch to 1 inch.

Once the reactor has been heated to a temperature of between 80 and 750° C. the pyrolysis reaction starts and the burner stops. Typically, the pyrolysis reaction continues until it finishes naturally.

The reactor is designed such that the access of oxygen to the reactor is limited, but not totally excluded from the reactor. Advantageously, the limited presence of oxygen during the reaction optimises the production of the composition and reduces the production of contaminants during the process.

In one embodiment, the reaction occurs within a pressure range of 0.2 MPa to 10 GPa.

The method may take place in an adjusted biochar kiln.

The feedstock is selected from the group consisting of pressed fruits and/or fruit pulp, vegetables, fruit stones, a by-product of whisky or beer, banana plants, coffee beans, plants, grass, leaves, herbs, olives, leaves, flowers, tea leaves and tea plants, solid digestate (waste products from an anerobic digestion process).

Advantageously, the composition may be prepared from a feedstock comprising a waste product of food production. In this embodiment, the composition is advantageously easily available at a low cost.

With reference to the figures, there is also provided a method of improving the quality of soil, compost, growing media or organic based fertiliser using a composition according to the invention. Advantageously, the use of the composition when applied to soil improves crop productivity.

In one embodiment, the composition is used as a soil fertility enhancer for agricultural and/or horticultural purposes. In another embodiment, the composition is used as a soil fertility enhancer for vertical farming. In another embodiment, the composition may be used in hydroponic systems.

Advantageously, the use of the composition improves the fertility of the soil, extends the soil fertility and reduces the quantity of fertilisers that may be required.

In one embodiment, the composition is used as a soil fertility enhancer for urban greening purposes, including green roofs and walls. Advantageously, the use of the composition improves the fertility of soils used for green roofs and walls, keeping the plants provided in the green roof or green wall alive with minimal effort.

In another embodiment, the composition is used as an active agent to clean soils from different contaminants, wherein the contaminants may include residues from herbicides and/or pesticides.

The composition may be used to enhance the properties of composts and similar growing media.

The composition may be used to enhance the properties of an organic fertiliser. Typically, the fertiliser comprises worm castings or manure-based fertilisers. Advantageously, the use of the composition makes the soil more fertile and more productive over a longer period of time than soil that does not comprise the composition.

Advantageously, since plants that are grown with the composition produce more crops and require less fertiliser, the use of the composition has great potential for the agricultural industry, especially in the growth of fruit and vegetable organic growing.

Advantageously, the composition may be used to generate a 30 to 40% higher crop production than plants that are grown using other growth media.

Advantageously, the composition has the ability to absorb herbicides and clean fertile soil for further cultivation.

### EXAMPLES

The composition of the present invention is referred to below as Pure Element.

### Soil Enhancement

A study was carried out to investigate the performance and productivity of spring barley grown under controlled laboratory conditions for 132 days in pots containing 3%, 5%, 20% and 30% by volume of Pure Element obtained from apple pulp mixed with arable soil. Treatments both with and without conventional inorganic fertiliser application were studied and soil only and perlite only controls were included. Once barley reached maturity, plant biomass and carbon and nitrogen contents were determined. Growth medium pH, electrical conductivity and mineral nitrogen contents were also determined. The Pure Element substrate was also chemically characterised.

The results of the study provide information about the chemical characteristics of the Pure Element, soil liming and conductivity effects as well as complex soil mineral nitrogen trends. This study showed that spring barley growth in fertilised and unfertilised soils receiving Pure Element was not greater than (i.e. as good as) spring barley grown in fertilised soil receiving no Pure Element. Similar or greater spring barley growth was found, however, compared to unfertilised soil (receiving no Pure Element). Spring barley growth was better for fertilised and unfertilised soils receiving Pure Element when compared to corresponding fertilised and unfertilised perlite controls receiving no Pure Element. For unfertilised growth media, root biomass increased with Pure Element addition. Spring barley stem, grain and root carbon and nitrogen contents were generally similar across treatments showing no difference in crop quality. Potentially beneficial soil liming effects and additional nitrogen/nutrient provision and possible retention were apparent.

In this experiment, Pure Element was produced through the pyrolysis of grape and apple pulp or other food waste materials. The raw materials used to make Pure Element and the pyrolysis technology used to produce it make Pure Element an economically viable option that may advantageously compete with regular commercially available plant growth media (e.g. inert inorganic expanded volcanic glass perlite) and soil enhancers (e.g. organic rich humic acid granules). Initial tests have shown that Pure Element when used as a soil enhancer provides beneficial conditions for crop growth. The results demonstrated Pure Element's ability to support plant growth and provide favourable nutrient cycling within agricultural crop and soil systems.

When applied to soil, Pure Element can improve aeration and soil structure for plant growth. The main advantage of Pure Element over commercially available growing media, such as perlite, is its ability to provide nutrients to the growing plants. Nutrient retention and provision by the material itself throughout plant growth avoids the need for application of additional fertilisers or nutritious components. Applying Pure Element to agricultural soils may reduce conventional fertiliser application requirements and provide multiple benefits for crop growth, soil health and environmental quality. Benefits may include long lasting nutrient provision, water retention, a favourable rooting environment, increased soil carbon storage and decreased greenhouse gas emissions and nutrient loss.

### Spring Barley Growth Experiment

In this study, 30 litres of apple pulp based Pure Element was used to conduct a barley growth experiment.

Arable soil and soil (0-20 cm depth) was collected from a field that had not recently received fertiliser. The soil type was a sandy loam/sandy silt loam, imperfectly drained brown earth.

Plant pots (2 litre volume, 15.5 cm diameter) were filled with different proportions of Pure Element (3%, 5%, 20% and 30% by volume). Appropriate proportions of fresh, sieved (4 mm) arable soils were mixed with Pure Element in pots to fill them to the same uniform volume. Control pots containing soil only and perlite only were also prepared. Ten replicate pots were prepared in total, with half receiving NPK (nitrogen, phosphorous, potassium) fertiliser and the other half unfertilised. Treatments are summarised in Table 1.

TABLE 1
Summary of spring barley growth experiment treatments

| Unfertilised treatment | Fertilised treatment |
|---|---|
| Soil only | Soil only |
| Perlite only | Perlite only |
| 30% Substrate + 70% Soil | 30% Substrate + 70% Soil |
| 20% Substrate + 80% Soil | 20% Substrate + 80% Soil |
| 5% Substrate + 95% Soil | 5% Substrate + 95% Soil |
| 3% Substrate + 97% Soil | 3% Substrate + 97% Soil |

There were 5 replicate pots for each treatment and pots were fertilised with NPK (nitrogen, phosphorous, potassium) fertiliser.

The pots were placed in saucers to avoid leaching and positioned on a bench, in a completely randomised design, in a temperature-controlled glasshouse (around 20° C.) with artificial lighting at night. Pots were sown with spring barley (malting cultivar Optic) seeds. Each pot (190 cm²) received nine barley seeds reflecting the recommended sowing rate of 360 per m². After seedling emergence, seedlings were thinned, selecting the four strongest barley plants per pot to remain so that comparable plants could be analysed when the growth experiment was terminated. The weakest seedlings were removed, chopped and added back into the pot that they were removed from. The NPK fertiliser was then evenly applied to the surface of the fertilised treatment pots. Fertiliser was applied using the recommended application rates for spring barley of 150 kg N/ha, 38 kg P/ha, 68 kg K/ha. The NPK fertiliser composition was as follows: ammonium nitrate with a composition of 39.5% nitrogen, super phosphate containing 46% phosphate and muriate of potash containing 60% potassium. This equated to the addition of 0.71 g N fertiliser, 0.16 g P fertiliser and 0.22 g K fertiliser to each pot.

Spring barley plants were watered frequently using a fine watering hose. Growth medium/soil moisture levels were maintained around 60 to 70% water holding capacity. Once the plants had reached maturity, 132 days after sowing, the plants were harvested. Above ground (i.e. stems and ears) material, residual roots (where possible) and growth media/soil from each of the replicate treatment pots were carefully separated for analysis.

### Results

### Pure Element Characterisation

Weighed sub-samples of Pure Element were placed in a muffle furnace overnight at 500° C. and reweighed to calculate ash content. Sub-samples of Pure Element were dried at 60° C. and ball milled before being analysed for carbon (C) and nitrogen (N) contents using a Flash 2000 elemental analyser.

Sub-samples of Pure Element were extracted with de-ionised water (1:5 substrate:water ratio) and the pH and electrical conductivity (EC) of centrifuged supernatants were determined using calibrated pH and EC meters. Sub-samples of Pure Element were extracted with 2 mM potassium chloride (KCl) (1:5 substrate: 2M KCl ratio) and the mineral N (ammonium-N and nitrate-N) contents of centrifuged supernatants were determined using a Skalar San continuous flow colorimetric autoanalyser.

### Spring Barley Plant Material Analysis

Spring barley stems, grain (separated from ears) and washed residual roots were dried at 60° C. and weighed. Materials were then chopped up and ball milled prior to determination of C and N contents using a Flash 2000 elemental analyser.

### Post-Harvest Growth Media Analysis

Growth media samples were re-homogenised after barley harvest and removal of roots. Sub-samples of all replicate treatment growth media/soils were extracted with de-ionised water (1:2 growth medium:water ratio) and the pH and EC of centrifuged supernatants were determined using calibrated pH and EC meters. Sub-samples were also extracted with 2 M KCl (1:2 growth medium:2 M KCl ratio) and the mineral N (ammonium and nitrate) contents of centrifuged supernatants were determined sing a Skalar San continuous flow colorimetric autoanalyser.

### Pure Element Characterisation

Chemical characterisation results for the apple pulp Pure Element substrate are presented in Table 2 below.

Table 2 shows mean values for ash contents, total carbon (C) and nitrogen (N) contents, pH, electrical conductivity and mineral N contents for apple pulp Pure Element

TABLE 2

| | | | | Electrical | Ammonium- | Nitrate-N |
|---|---|---|---|---|---|---|
| Ash | Total C | Total N | | conductivity | N content | content |
| content | content | content | pH (1.5 | (mS/cm) (1:5 | (mg/kg) (1:5 | (mg/kg) (1:5 |
| (% by | (% by | (% by | substrate:water | substrate:water | substrate:2M KCl | substrate:2M KCl |
| mass)* | mass)* | mass)* | ratio)** | ratio)** | ratio)** | ratio)** |
| 15 +/− 0 | 70 +/− 9 | 2.71 +/− 0.29 | 9.4 +/− 0.0 | 13.5 +/− 0.5 | 2.30 +/− 0.77 | 0.90 +/− 0.17 |

*Number of replicate sub-samples analysed
*n = 4 and
**n = 2

The Pure Element had a high organic matter content of approximately 85% (as indicated by the ash content of 15%), high carbon content and nutrient N contents. The high pH value (measure of hydrogen ion activity in solution) found for Pure Element, perhaps due to carbonates, indicates that it could offer soil liming/neutralising value benefits for acidic agricultural soils. The electrical conductivity (EC) value provides a measure of soluble ions/salts in Pure Element which may be dependent on its degree of carbonisation. The EC value measured indicates that Pure Element may contain a high salt content.

### Spring Barley Growth Experiment

### Spring Barley Growth

Notable plant performance observations over time were recorded. FIG. 1 shows spring barley seedling emergence (7 days after sowing) following treatment with Pure Element. FIG. 2 shows an example of the mature spring barley plants (132 days after sowing) before harvest. Treatment order from left to right of the plants shown in FIG. 2 (unfertilised on the left and fertilised on the right for each treatment group): Perlite only, soil only, 3% Pure Element, 5% Pure Element, 20% Pure Element, 30% Pure Element.

FIGS. 3a to 3j show the effect of various treatments on plants after 40 days growth, where the treatments are as follows:

FIG. 3a—Soil only (unfertilised)

FIG. 3b—Soil only (fertilised)

FIG. 3c—Perlite only (unfertilised)

FIG. 3d—Perlite only (fertilised)

FIG. 3e—30% Pure Element and 70% Soil (unfertilised)

FIG. 3f—30% Pure Element and 70% Soil (fertilised)

FIG. 3g—20% Pure Element and 80% Soil (unfertilised)

FIG. 3h—20% Pure Element and 80% Soil (fertilised)

FIG. 3i—5% Pure Element and 95% Soil (unfertilised)

FIG. 3j—5% Pure Element and 95% Soil (fertilised)

FIGS. 4a to 4f show the effect of various treatments on plants before harvest after 132 days growth, where the treatments are as follows:

FIG. 4a—Soil only (fertilised on the right hand side and unfertilised on the left hand side) FIG. 4b—Perlite only (fertilised on the right hand side and unfertilised on the left hand side)

FIG. 4c—30% Pure Element and 70% Soil (fertilised on the right hand side and unfertilised on the left hand side)

FIG. 4d—20% Pure Element and 80% Soil (fertilised on the right hand side and unfertilised on the left hand side)

FIG. 4e—5% Pure Element and 95% Soil (fertilised on the right hand side and unfertilised on the left hand side)

FIG. 4f—3% Pure Element and 97% Soil (fertilised on the right hand side and unfertilised on the left hand side)

In general, the barley plants growing in treatments with 20% and 30% Pure Element applied (fertilised and unfertilised) appeared to look more robust and stronger than other comparable fertilised and unfertilised treatments. The surface soil tilth also appears to be better with less weed emergence for Pure Element treated soils. Unfertilised plants all showed signs of nutrient deficiency but plants in unfertilised Pure Element treatments performed better than perlite and soil-only controls. Plants growing in perlite-only control (fertilised and unfertilised) showed less vigour.

### Spring Barley Above Ground and Below Ground Biomass Measurements

Barley above ground (stems and ears) and below ground (roots) biomass results are shown in FIGS. 5 and 6, respectively. FIG. 5 shows spring barley above ground (stems and ears) biomass results across treatments. FIG. 6 shows spring barley below ground (roots) biomass results across treatments. The number of replicates (n) is 5 for all treatments except ‘soil only unfertilised’ wherein n=3 and ‘5% Pure Element unfertilised’ wherein n=4. Above ground and below ground biomass was much higher for fertilised treatments than unfertilised treatments. Above ground biomass produced for fertilised treatments were highest for soil-only and 20% and 30% Pure Element treatments, showing similar masses, and lowest for the perlite-only treatment. Unfertilised 30% and 20% Pure Element had the highest above ground biomass out of the unfertilised treatments, and perlite-only the lowest. These findings suggest that Pure Element applied to fertilised soil did not increase barley productivity relative to fertilised soil alone. Conversely, Pure Element applied to unfertilised soil at 20% and 30% by volume increased barley productivity relative to unfertilised soil alone.

Root biomass was highest for the fertilised perlite-only treatment because it is easier to wash and recover residual roots from inert inorganic perlite than organic-rich ‘sticky’ soil and Pure Element substrates. As for above ground biomass, root biomass was highest for fertilised soil-only and fertilised 20% and 30% Pure Element treatments. The much higher unfertilised 20% and 30% Pure Element root biomass measurements, compared to other unfertilised soil treatments, may be due to increased barley productivity but higher root biomass could also be attributable to Pure Element's ability to improve soil porosity and structure.

### Spring Barley Stem, Grain and Root Carbon Nitrogen Contents

Spring barley stem, grain and root carbon and nitrogen contents are shown in FIGS. 7, 8 and 9, respectively.

FIG. 7a shows spring barley stem carbon contents across treatments. FIG. 7b shows spring barley nitrogen contents across treatments.

FIG. 8a shows spring barley grain carbon contents across treatments and FIG. 8b shows spring barley grain nitrogen contents across treatments. The number of replicates (n) is 5 for all treatments except ‘perlite only unfertilised’ where n=3.

Stem, grain and root carbon contents were similar across treatments. Stem N contents were highest for unfertilised soil only, perlite only (fertilised and unfertilised) and unfertilised 3 and 5% Pure Element treatments. Grain N contents were also highest for unfertilised soil only and unfertilised 3% Pure Element treatments. Note that the optimum grain N content for spring barley, desired by malsters, is 1.5% but this controlled laboratory experiment may not be completely comparable to real field conditions. Root N contents were variable across treatments with high errors in some cases but noticeably low for perlite treatments as no additional N was being supplied (though soil or Pure Element) and no soil N would have been sticking to roots in these treatments.

FIG. 9a shows spring barley root carbon contents across treatments. FIG. 9b shows spring barley root nitrogen contents across treatments. The number of replicates (n) is 5 for all treatments except ‘soil only unfertilised’ wherein n=2 and ‘5% Pure Element unfertilised’ where n=4.

### Post-Harvest Growth Media pH and Electrical Conductivity

Measured pH and EC values across all post-harvest growth media treatments are shown in FIG. 9. Growth media pH values are greatest for unfertilised perlite-only and fertilised and unfertilised 20% and 30% Pure Element treatments. The high perlite-only pH is surprising as this growth medium was expected to be closer to neutral. It is worth noting that soil extraction methods were applied that may not have been completely appropriate for perlite-only treatments. A soil liming effect that increases with the volume of Pure Element applied is evident. A comparison of the unfertilised and fertilised treatments indicates that the ammonium nitrate fertiliser addition had a slightly acidifying effect.

FIG. 10a shows post-harvest growth media pH across treatments. FIG. 10b shows post-harvest growth media electrical conductivity (EC) across treatments. Initial arable soil, used to set up the experiment, had pH and EC values of 6.37+/−0.03 and 141+/−1 μS/cm, respectively.

Electrical conductivity values are greatest for perlite and 20% and 30% Pure Element treatments (fertilised and unfertilised) (see FIG. 10b). An increase in soluble salts is expected for addition of Pure Element to soils. As already mentioned, soil extraction methods applied for EC measurement may not have been completely appropriate for perlite-only treatments.

### Post Harvest Growth Media Mineral Nitrogen Contents

Measured mineral N contents across all post-harvest growth media treatments are shown in FIGS. 11a and 11b.

FIG. 11a shows post-harvest growth media ammonium-N contents across treatments. FIG. 11b shows post-harvest growth media nitrate-N contents across treatments. Initial arable soil, used to set up the experiment, had ammonium-N and nitrate-N contents of 0.87+/−0.03 mg/kg and 29.5+/−0.4 mg/kg, respectively. The number of replicates (n) is 5 for all treatments but erroneous values were removed for perlite treatments. For ‘perlite only unfertilised’ n=3 for ammonium and n=4 for nitrate. For ‘perlite only fertilised’ n=4 for ammonium and n=2 for nitrate.

Mineral N contents found for post-harvest growth media were highly variable with no clear trends (FIG. 11). Soil extraction methods applied for mineral N content measurement may not have been appropriate for perlite-only treatments and therefore the data for soil treatments are most reliable.

Soil ammonium-N contents were generally highest for fertilised 3%, 5% and 20% Pure Element treatments but not fertilised 30% Pure Element. This was surprising but is understood to be due to increased plant update of N (high yields found for this 30% treatment), increased conversion to nitrate or increased retention/adsorption of ammonium-N to available Pure Element surfaces. The Pure Element treatments would have had the highest ammonium-N contents (compared with soil only controls) at the start of the experiment, as Pure Element ammonium-N contents are higher than initial soil ammonium-N contents.

The generally higher soil nitrate-N contents in the fertilised and unfertilised soil-only controls may be due to these treatments having the highest nitrate-N contents at the start of the experiment, as Pure Element nitrate-N contents are lower than initial soil nitrate-N contents. Also, ammonium-N present at the start of the experiment may have been bound to soil less strongly than to Pure Element and therefore soil-only control ammonium-N would have been converted to nitrate-N more readily through the process of nitrification.

Addition of mineral N at the start of the experiment, particularly Pure Element ammonium-N and soil nitrate-N needs consideration but so do the complex soil N transformations that occur. Soil and Pure Element also contain organic pools of N which can be converted to mineral N pools through mineralisation processes, thus explaining the higher ammonium-N contents found for unfertilised post-harvest control soils compared to initial soil ammonium-N contents. Furthermore, it is worth noting that denitrification processes where nitrate-N is reduced and converted to dinitrogen gas, and most importantly greenhouse gas nitrous oxide, are more likely to occur under acidic wet soil conditions.

Soil N transformations are complex, dependent on many factors such as pH, moisture, organic and inorganic (mineral) N pools, fertiliser and other forms of inorganic and organic N application, soil microbial activity, adsorption and desorption processes and plant N uptake.

### Overall Spring Barley Growth Experiment Findings

The outcomes from these experiments described herein show that spring barley growth in fertilised and unfertilised soils receiving Pure Element were not greater than (i.e. as good as) spring barley grown in the fertilised soil-only control. However, similar or greater spring barley grown was found when compared to the unfertilised soil-only control. Spring barley growth was greater for fertilised and unfertilised Pure Element treatments when compared to the corresponding fertilised and unfertilised perlite-only controls. For unfertilised treatments, root biomass appeared to increase with Pure Element addition, possibly due to soil porosity improvements.

Spring barley plant material C and N contents were generally similar across treatments showing no difference in crop quality. Grain N contents were not as high as the optimal value for maltsters but controlled experimental conditions used may not be directly comparable to real field conditions. Potentially beneficial soil liming effects and additional N provision, with the possibility of N retention and slow release to growing plants over time were apparent. Overall, the study indicated that the addition of Pure Element to arable soils (such as those used for barley production) may have some beneficial properties for plant growth and productivity, particularly as society moves towards alternative less-intensive agricultural practices in the future that require less inputs such as conventional NPK fertiliser and lime application.

Thus, the use of Pure Element in agricultural soils has beneficial properties that may be used to support crop growth, soil liming and soil N retention in future less intensive agricultural systems. The use of Pure Element may have an overall positive impact on soil health and crop productivity.

### Analysis of Pure Element Samples

The composition of Pure Element produced from apple pulp and from sunflower was measured and compared with biochar obtained from wood. The compositions were found to include the following components (measured on a dry matter basis).

TABLE 3
Composition of wood based biochar
Analytical results on dry matter basis

| Determinand | Units | Value | Amount per fresh ton |
|---|---|---|---|
| pH 1.6 [Fresh] | | 7.45 | |
| Oven Dry Matter | % | 95.0 | 950.0 kg DM |
| Total Nitrogen | % w/w | 0.48 | 9.12 Units N |
| Ammonium Nitrogen | mg/kg | 14.7 | 0.03 Units NH4-N |
| Nitrate Nitrogen | mg/kg | <10 | <0.01 Units NO3-N |
| Total Phosphorous (P) | % w/w | 0.032 | 1.39 Units P2O5 |
| Total Potassium (K) | % w/w | 0.216 | 4.95 Units K2O |
| Total Magnesium (Mg) | % w/w | 0.121 | 3.82 Units MgO |
| Total Sulphur (S) | % w/w | 0.162 | 7.70 Units SO3 |
| Total Copper (Cu) | mg/kg | 4.59 | <0.01 kg Cu |
| Total Zinc (Zn) | mg/kg | 24.9 | 0.02 kg Zn |
| Total Sodium (Na) | % w/w | 0.049 | 0.47 kg Na |
| Total Calcium (Ca) | mg/kg | 24114 | |
| Total Carbon | % w/w | 37.1 | |
| Organic Matter LOI | % w/w | 54.7 | |

TABLE 4
Composition of Pure Element from apple
Analytical results on dry matter basis

| Determinand | Units | Value | Amount per fresh ton |
|---|---|---|---|
| pH 1.6 [Fresh] | | 8.63 | |
| Oven Dry Matter | % | 96.5 | 965.0 kg DM |
| Total Nitrogen | % w/w | 2.39 | 46.13 Units N |
| Ammonium Nitrogen | mg/kg | 35.2 | 0.07 Units NH4-N |
| Nitrate Nitrogen | mg/kg | <10 | <0.01 Units NO3-N |
| Total Phosphorous (P) | % w/w | 0.513 | 22.67 Units P2O5 |
| Total Potassium (K) | % w/w | 2.50 | 58.14 Units K2O |
| Total Magnesium (Mg) | % w/w | 0.117 | 3.75 Units MgO |
| Total Sulphur (S) | % w/w | 0.247 | 11.92 Units SO3 |
| Total Copper (Cu) | mg/kg | 17.9 | 0.02 kg Cu |
| Total Zinc (Zn) | mg/kg | 30.1 | 0.03 kg Zn |
| Total Sodium (Na) | % w/w | 0.025 | 0.24 kg Na |
| Total Calcium (Ca) | mg/kg | 7630 | |
| Total Carbon | % w/w | 66.0 | |
| Organic Matter LOI | % w/w | 88.5 | |

TABLE 5
Composition of Pure Element obtained from Sunflower plants
Analytical results on dry matter basis

| Determinand | Units | Value | Amount per fresh ton |
|---|---|---|---|
| pH 1.6 [Fresh] | | 9.57 | |
| Oven Dry Matter | % | 94.1 | 941.0 kg DM |
| Total Nitrogen | % w/w | 0.93 | 17.50 Units N |
| Ammonium Nitrogen | mg/kg | <10 | <0.01 Units NH4-N |
| Nitrate Nitrogen | mg/kg | <10 | <0.01 Units NO3-N |
| Total Phosphorous (P) | % w/w | 0.131 | 5.65 Units P2O5 |
| Total Potassium (K) | % w/w | 2.15 | 48.76 Units K2O |
| Total Magnesium (Mg) | % w/w | 0.362 | 11.31 Units MgO |
| Total Sulphur (S) | % w/w | 0.147 | 6.92 Units SO3 |
| Total Copper (Cu) | mg/kg | 18.7 | 0.02 kg Cu |
| Total Zinc (Zn) | mg/kg | 27.0 | 0.03 kg Zn |
| Total Sodium (Na) | % w/w | 0.005 | 0.05 kg Na |
| Total Calcium (Ca) | mg/kg | 8715 | |
| Total Carbon | % w/w | 72.6 | |
| Organic Matter LOI | % w/w | 90.6 | |

From the above, it can be seen that Pure Element obtained from apple and from sunflower plants has a composition of 66% and 72.6% total carbon, whereas the total amount of carbon from wood based biochar is 37.1%.

Another experiment was carried out to assess the ash, carbon and nitrogen content from samples of Pure Element obtained from apples and grapes. The presence of plant nutrients and ash within Pure Element assist in improving the properties of soil. Table 6 below shows the mean values (n=4) for ash contents, total carbon contents and total nitrogen contents for Pure Element samples. The Pure Element samples comprised three apple samples (A1, A2 and A3) and a grape sample (G2). A control sample was used (Original).

These samples were analysed using standard analytical techniques.

TABLE 6

| Pure Element | Ash | Total Carbon | Total Nitrogen |
|---|---|---|---|
| Sample ID | Content (%) | Content (%) | Content (%) |
| A1 | 12.55 +/− 0.34 | 73.3 +/− 2.61 | 3.61 +/− 0.181 |
| A3 | 11.68 +/− 0.57 | 74.5 +/− 10.9 | 1.57 +/− 0.155 |
| A4 | 9.18 +/− 0.11 | 68.2 +/− 9.19 | 1.69 +/− 0.615 |
| G2 | 23.33 +/− 1.21 | 74.0 +/− 14.7 | 1.75 +/− 0.383 |
| Original | 14.89 +/− 0.15 | 70.1 +/− 8.85 | 2.71 +/− 0.293 |

A further analysis of a Pure Element sample from whisky draff was carried out and the results are provided below:

TABLE 7

| | | | | As | Dry |
|---|---|---|---|---|---|
| Parameter | Method | LOQ | Unit | received | basis |
| Moisture | DIN | 0.1 | % (w/w) | 7.1 | — |
| | 51718:2002-06 | | | | |
| Ash content | DIN | 0.1 | % (w/w) | 4.8 | 5.2 |
| (815° C.) | 51719:1997-07 | | | | |
| Carbon | DIN | 0.2 | % (w/w) | 81.3 | 87.5 |
| | 51732:2014-07 | | | | |
| Carbon | berechnet | | % (w/w) | 80.8 | 87.0 |
| (organic) | | | | | |
| Hydrogen | DIN | 0.1 | % (w/w) | 1.2 | 1.3 |
| | 51732:2014-07 | | | | |
| Total | DIN | 0.05 | % (w/w) | 2.78 | 2.99 |
| nitrogen | 51732:2014-07 | | | | |
| Sulphur (S), | DIN | 0.03 | % (w/w) | 0.07 | 0.07 |
| total | 51724-3:2012-07 | | | | |
| Oxygen | DIN | | % (w/w) | 2.7 | 2.9 |
| | 51733:2016-04 | | | | |
| Total | DIN | 0.1 | % (w/w) | 0.5 | 0.5 |
| inorganic | 51726:2004-06 | | | | |
| carbon (TIC) | | | | | |
| Carbonate- | DIN | 0.4 | % (w/w) | 1.7 | 1.8 |
| CO2 | 51726:2004-06 | | | | |
| H/C ratio | berechnet | | | | 0.17 |
| (molar) | | | | | |
| H/Corg ratio | berechnet | | | | 0.18 |
| (molar) | | | | | |
| O/C ratio | berechnet | | | | 0.025 |
| (molar) | | | | | |

LOQ means Limit of Quantification.

A further analysis to measure the heavy metal components of a Pure Element sample from whisky draff was carried out and the results are provided below:

TABLE 8

| Parameter | Method | LOQ | Unit | As received | Dry basis |
|---|---|---|---|---|---|
| Water holding | DIN EN ISO 14238, | | % | — | 70.5 |
| capacity (WHC) | A: 2014-3 | | | | |
| Moisture | DIN 51718: | 0.1 | % (w/w) | 7.9 | — |
| | 2002-06 | | | | |
| Napthalene | DIN EN 16181: | 0.1 | mg/kg | — | 12 |
| | 2019-08 | | | | |
| Acenaphthylene | DIN EN 16181: | 0.1 | mg/kg | — | <0.1 |
| | 2019-08 | | | | |
| Acenapthene | DIN EN 16181: | 0.1 | mg/kg | — | <0.1 |
| | 2019-08 | | | | |
| Fluorene | DIN EN 16181: | 0.1 | mg/kg | — | <0.1 |
| | 2019-08 | | | | |
| Phenanthrene | DIN EN 16181: | 0.1 | mg/kg | — | 1.0 |
| | 2019-08 | | | | |
| Anthracene | DIN EN 16181: | 0.1 | mg/kg | — | 0.1 |
| | 2019-08 | | | | |
| Fluoranthene | DIN EN 16181: | 0.1 | mg/kg | — | 0.2 |
| | 2019-08 | | | | |
| Pyrene | DIN EN 16181: | 0.1 | mg/kg | — | 0.1 |
| | 2019-08 | | | | |
| Benz(a)anthracene | DIN EN 16181: | 0.1 | mg/kg | — | <0.1 |
| | 2019-08 | | | | |
| Chrysene | DIN EN 16181: | 0.1 | mg/kg | — | <0.1 |
| | 2019-08 | | | | |
| Benzo(b)fluoranthene | DIN EN 16181: | 0.1 | mg/kg | — | <0.1 |
| | 2019-08 | | | | |
| Benzo(k)fluoranthene | DIN EN 16181: | 0.1 | mg/kg | — | <0.1 |
| | 2019-08 | | | | |
| Benzo(a)pyrene | DIN EN 16181: | 0.1 | mg/kg | — | <0.1 |
| | 2019-08 | | | | |
| Indeno(1,2,3-cd)pyrene | DIN EN 16181: | 0.1 | mg/kg | — | <0.1 |
| | 2019-08 | | | | |
| Dibenz(a,h) | DIN EN 16181: | 0.1 | mg/kg | — | <0.1 |
| anthracene | 2019-08 | | | | |
| Benzo(g,h,i)perylene | DIN EN 16181: | 0.1 | mg/kg | — | <0.1 |
| | 2019-08 | | | | |
| Total 16 EPA-PAH | DIN EN 16181: | | mg/kg | — | 13.4 |
| excl. LOQ | 2019-08 | | | | |

LOQ means Limit of Quantification.

Results for Pure Element obtained from whisky by product compared with wood based biochar samples

Table 9 below shows mean values (n=3) for loss on ignition (LOI) and ash contents, total carbon contents and total nitrogen contents for wood based biochar and whisky by product (grains) Pure Element samples.

TABLE 9

| | | Ash | Total carbon | Total nitrogen |
|---|---|---|---|---|
| Sample ID | LOI (%) | content (%) | content (%) | content (%) |
| Wood-based | 52.72 +/− 1.42 | 47.28 +/− 1.42 | 44.32 +/− 4.97 | 0.335 +/− 0.032 |
| biochar | | | | |
| Whisky by | 94.15 +/− 0.93 | 5.85 +/− 0.93 | 79.02 +/− 2.76 | 2.184 +/− 0.084 |
| product Pure | | | | |
| Element | | | | |

Table 10 below shows results for draff (spent grain from distilling) Pure Element samples. Table 10 shows mean values and standard deviations (n=2) for loss on ignition (LOI) and ash contents, total carbon contents and total nitrogen contents for draff-based Pure Element.

TABLE 10

| | | Ash | Total carbon | Total nitrogen |
|---|---|---|---|---|
| Sample ID | LOI (%) | content (%) | content (%) | content (%) |
| Draff S1 | 88.96 +/− 0.81 | 11.04 +/− 0.81 | 73.83 +/− 0.71 | 4.976 +/− 0.036 |
| Draff S2 | 92.49 +/− 0.01 | 7.52 +/− 0/.01 | 68.27 +/− 0.32 | 5.336 +/− 0.028 |
| Draff S3 | 91.49 +/− 0.17 | 8.51 +/− 0.17 | 68.75 +/− 0.01 | 5.785 +/− 0.019 |

Surface properties of Pure Element

Four samples of Pure Element (referred to below as P55/20, P50/20, P42/20 and P40/20) were characterised in terms of their surface properties. Key findings from the analysis are the hierarchical pore size distribution: microporous and mesoporous structures within the Pure Element and the basic nature of the surface of the samples.

Characterisation of the textural properties was measured with adsorption isotherms, using a Micrometrics ASAP 2020 analyser. N₂ isotherms were measured at 77K to identify key textural properties including specific surface area and porosity. CO₂ isotherms at 273K were measured to identify and quantify ultramicropores (pore size <7 nm) whilst CO₂ isotherms at 298 K were measured to identify CO₂ adsorption capacity in line with the evaluation of one of the applications agreed for this study (CO₂ capture). Regarding calculations, the specific surface area of the adsorbents was determined by applying the Brunauer-Emmett-Teller (BET) method, whilst micropore volumes were determined by the application of Dubinin Raduschkevich (DR) equation, and the total pore volume was determined using the Gurevich's law. The point of zero charge (pH_{PZC}) was measured to determine the surface basicity/acidity of the adsorbents, and it was done by the mass titration procedure described by Noh et al (Industrial and Engineering Chemistry Research,

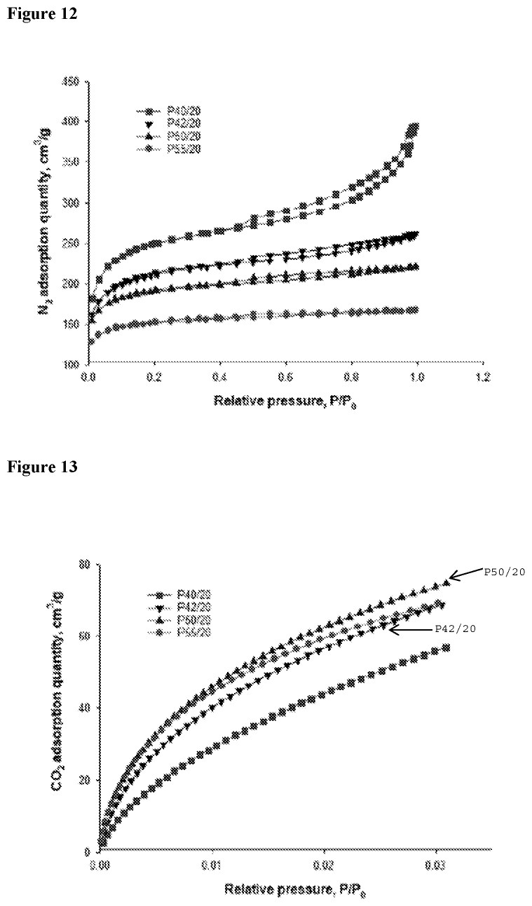

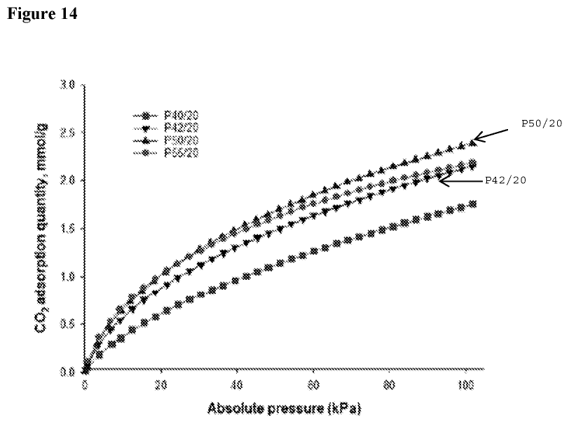

FIGS. 12 to 14 depict the isotherms measured for each sample, with respective quantification of the relevant textural parameter values presented in Tables 12 and 13. FIG. 12 shows N₂ isotherms at 77K of the Pure Element samples. FIG. 13 shows CO₂ isotherms at 273K of the Pure Element samples. FIG. 14 shows CO₂ isotherms at 298 K of the Pure Element samples.

From the N₂ adsorption isotherms at 77K (FIG. 12) it is observed the presence of hysteresis loops in all samples, but most definitely in sample P40/20. This indicates the presence of mesopores (pores of diameter range 2 to 50 nm). Calculations from the DR equation and method confirms this in Table 12 with P40/20 which in FIG. 12 has the largest hysteresis loop, possessing the largest mesopore volume and total pore volume. Despite evidence of mesoporisity, the convex curvature of the isotherms for samples P42/20, P50/20 and P55/20 resembles Type 1 in the IUPAC classification, which indicates a predominantly microporous (pore diameter <2 nm) structure. This is reflected in pore volume calculations with P55/20 possessing the largest fraction of micropores of the four ACs. Sample P40/20 was determined as possessing the largest specific surface area in addition to the largest total pore volume, whereas P50/20, the most microporouos sample, possesses the lowest specific area which highlights an inverse relation between pore size and specific surface area which highlights an inverse relation between pore size and specific surface area across the four samples prepared. The calculated average pore diameter (D) (see Table 9) shows that samples P55/20, P50/20 and P42/20 possess average pore sizes close to 2 nm (within the micropore size range), confirming a milder mesoporous content compared to P40/20. Additionally, pH_{PZC} calculations show the predominantly high basic surface character that all four samples possess, indicating the presence of basic surface functional groups.

FIG. 13 depicts the CO₂ adsorption isotherms at 273 K for each sample. P50/20 exhibits the largest uptake and hence largest ultramicropore presence, which is reflected in calculations in Table 10 with its possessing of the largest ultramicropore volume (W_{0, ultra} in Table 10), however the uptakes and ultramicropore volumes of P55/20 and P42/20 are similar. The substantially lower ultramicropore presence in P40/20 compared to other adsorbents is attributed to its larger mesopore presence together with its bigger average diameter (D) and average narrow width (L₀).

The CO₂ adsorption isotherms measured at room temperature (FIG. 14) reflect the textural properties calculations from the previous two isotherms (FIGS. 12 and 13). Whilst P55/20, P50/20 and P42/20 possess similarity substantial CO₂ uptakes because of their largely microporous structures, P40/20, the least microporous sample, shows the lowest uptake. It is also evident that a higher specific area does not necessarily equate to a higher adsorption capacity under tested conditions, however in the cases of P50/20 and P55/20 that possess similar micropore structures, the larger surface area and larger pore volume for P50/20 may account for its higher uptake range.

Table 11 below shows textural properties obtained from the N₂ isotherms at 77K, and pH_{,PZC} for the Pure Element Samples.

TABLE 11

| | S_{BET}^{a} | W_{T}^{b} | W₀^{c} | | Wₘₑₛₒ^{e} | D^{f} | L₀^{g} | |
|---|---|---|---|---|---|---|---|---|
| Sample | (m²/g) | (cm³/g) | (cm³/g) | W₀/W_{T}^{d} | (cm³/g) | (nm) | (nm) | pH, _{PZC}^{h} |
| P55/20 | 502 | 0.26 | 0.23 | 0.88 | 0.03 | 2.05 | 1.15 | 9.31 |
| P50/20 | 573 | 0.34 | 0.29 | 0.85 | 0.05 | 2.29 | 1.43 | 9.67 |
| P42/20 | 694 | 0.41 | 0.32 | 0.78 | 0.09 | 2.33 | 1.83 | 10.22 |
| P40/20 | 764 | 0.61 | 0.38 | 0.62 | 0.23 | 3.19 | 2.60 | 10.41 |

^{a}Specific surface area;
^{b}Total pore volume;
^{c}Total micropore volume;
^{d}Micropore volume ratio;
^{e}Total mesopore volume;
^{f}Average pore diameter;
^{g}Average pore width;
^{h}point of zero charge.

Table 12 below shows the textural properties obtained from the CO₂ isotherms at 273K for the Pure Element samples.

TABLE 12

| Sample | ^{a}W_{0,} ᵤₗₜᵣₐ (nm) | ^{b}E₀ (KJ/mol) | ^{c}L_{0,} ᵤₗₜᵣₐ (nm) |
|---|---|---|---|
| P55/20 | 0.23 | 29.49 | 0.60 |
| P50/20 | 0.24 | 29.17 | 0.61 |
| P42/20 | 0.23 | 28.24 | 0.64 |
| P40/20 | 0.17 | 26.86 | 0.70 |

^{a}Ultramicropore volume;
^{b}Characteristic energy;
^{c}Average ultramicropore width.

The experimental characterisation results presented previously indicate promising applications of the Pure Element samples in the following areas: CO₂ capture (from different gaseous mixtures such as flue gas and biogas purification), soil enrichment and pharmaceutical wastewater treatment.

### CO₂ Capture

Carbon Capture Utilisation and Storage (CCUS) has emerged as an important strategy for curbing warming rates and subsequent climate change that has been accelerated due to greenhouse (GHGs) emissions (Mukherjee et al, Journal of Environmental Sciences (China), 83 (2019), 46-63). Current commercial CO₂ capture use liquid amine solvents, however key drawbacks of such technology include large energy requirements for stripping, degradation to equipment and the environmental risk in their disposal.

Table 13 depicts the CO₂ uptakes of the characterised Pure Element samples, together with the uptakes obtained for commercial ACs, zeolites and other biomass-based ACs for CO₂ capture. It can be observed that Pure Element samples show either superior or comparable uptake ranges, highlighting their promising potential for this application. This is mainly due to the predominantly microporous nature of the Pure Element and presence of ultramicropores within the Pure Element. Their ability for uptake is also supplemented by their surface highly basic character, which improves adsorbate-adsorbent affinity, as CO₂ is weakly acidic. A key challenge to the implementation of biomass-based ACs aside from their uptake potential is the feasibility to translate laboratory producibility into a commercial scale, which the Pure Element samples possess advantageously.

Table 13 shows the CO₂ adsorption capacity of the Pure Element samples and activated carbons.

TABLE 13

| Adsorbents | CO₂ update at 298 K (mmol/g) |
|---|---|
| Coconut shell AC | 1.8 (Rashidi et al, Clean Technologies and |
| | Environmental Policy 16 (2014) 1353-1361). |
| Almond shell AC | 2.7 (Gonzalez et al, Chemical Engineering |
| | Journal 230 (2013), 456-465). |
| Coffee residue AC | 2.4 (Plaza et al, Applied Energy 99 (2012), |
| | 272-279). |
| Pallm shell (modified, mono-ethanolamine) | 1.11 (Khalil et al, Chemical Engineering |
| | Journal 183 (2012), 15-20). |
| Commercial granular AC (GAC) | 1.2 (Shafeeyan et al, Applied Surface |
| | Science 257 (2011), 3936-3942). |
| Norit RB2 | 2.5 (Millward et al, Journal of the American |
| | Chemical Society 127 (2005), 17998-17999) |
| P55/20 | 2.18 |
| P50/20 | 2.39 |
| P42/20 | 2.15 |
| P40/20 | 1.75 |
| Zeolite 13X | 1.77 (Konduru et al, AIChE Journal 53 |
| | (2007) 3137-3143) |
| Zeolite SSZ-13 | 3.98 (Hudson et al, Journal of the American |
| | Chemical Society 134 (2012), 1970-1973) |

### Soil Enrichment

The microporous/mesoporous nature of the Pure Element investigated in this study indicates suitability for molecular adsorption and transport, which would allow for effective nutrient retention and water retention in soils. This impact would render these samples as beneficial for various soil-based applications including agriculture, gardening or land management.

### Wastewater Treatment: Pharmaceuticals

Advances in medicine have resulted in higher drug use across the world which in turn has led to higher quantities of pharmaceutical waste disposal, with primary sources including hospitals, factory sites and households (Wong et al, A Short Review: Journal of Cleaner Production, 175 (2018), 361-375). There is growing concern over bioaccumulation of pharmaceuticals because of their lack of biodegradability and reports to even evade standard wastewater treatment plant processes (Calisto et al, Environmental Management, 192 (2017), 15-24). Also factoring in their impact to human and likely animal or plant health, the guarantee of their efficient and safe disposal is of growing interest. Activated Carbons, which have been employed in general wastewater applications such as the removal of heavy metals and dyes are of particular interest for pharmaceutical wastewater treatment because of key attributes such as their porosity. The use of biomass-based adsorbents is also considered as beneficial to the circular economy.

Table 14 details the properties of activated carbons that have been deemed to have adsorbed their targets pollutants to a satisfactory capacity. Added in are the textural properties of the Pure Element samples analysed in this study. Evident is the similarity in porosity and surface area of the samples to that of the ACs from literature, highlighting that the Pure Element samples show potential based on their textural properties for the pollutants mentioned, which are prominently in pharmaceutical applications. The microporous/mesoporous character of all four samples investigated in this study, together with the order of magnitude of their specific surface areas indicate particular potential for the removal of mental health related pharmaceuticals such as oxazepam and paroxetine as well as carbamazepine, which is considered an emerging contaminant and currently required close monitoring in its disposal (Calisto et al, Environmental Management, 192 (2017), 15-24). Other pharmaceuticals to which these adsorbents are suited, according to their textural properties, include atenolol (blood pressure) and acebutolol (hypertension), hydroquinone (skin treatment) and nitrophenol compounds that are used in drug production. Specific surface area is linked more directly with improving adsorption performance for pharmaceuticals hence samples P40/22 and P42/20 are indicatively the most promising of the four adsorbents investigated.

Table 14 shows the textural properties of the Pure Element samples when compared with Activated Carbon samples from literature, studied for the removal of pharmaceutical compounds with satisfactory results.

TABLE 14

| | Textural | Pharmaceutical | Adsorption | |
|---|---|---|---|---|
| Adsorbent | Properties | pollutant | capacity | Reference |
| Palm kernel shell | S_{BET} = 711.5 m²/g | Acebutolol (ACE) | 0.69 mmol/g (ACE) | To et al, |
| activated carbon | W_{T} = 0.42 cm³/g | Atenolol (ATE) | 0.67 mmol/g (ATE) | Journal of |
| | W₀ = 0.24 cm³/g | Carbamazepine (CBZ) | 0.72 mmol/g (CBZ) | Molecular |
| | Wₘₑₛₒ = 0.18 cm³/g | | | Lipids 241 |
| | D = 0.18 nm | | | (2017), 386- |
| | | | | 398 |
| Commercial | S_{BET} = 848 m²/g | Carbamazepine (CBZ) | 493 mg/g (ACE) | Calisto et al, |
| activated carbon | W₀ = 0.36 cm³/g | Oxazepam (OXZ) | 405 mg/g (OXZ) | Journal of |
| | | Paroxetine (PAR) | 272 mg/g (PAR) | Environmental |
| | | | | Management |
| | | | | 192 (2017), |
| | | | | 15-24) |
| Sawdust activated | S_{BET} = 619 m²/g | Hydroquinone (HYQ) | 276 mg/g (HYQ) | Alvarez- |
| carbon (Co/MW | W_{T} = 0.34 cm³/g | O-Nitrophenol (ONP) | 332 mg/g (ONP) | Torrellas et al, |
| activated) | D = 2.2 nm | | | Applied |
| | | | | Surface |
| | | | | Science 414 |
| | | | | (2017), 424- |
| | | | | 434 |
| Peach stone | S_{BET} = 679 m²/g | p-Nitrophenol | 234 mg/g | Thue et al, |
| activated carbon | W_{T} = 0.31 cm³/g | | | Journal of |
| | W₀ = 0.30 cm³/g | | | Colloid and |
| | Wₘₑₛₒ = 0.01 cm³/g | | | Interface |
| | | | | Science 486 |
| | | | | (2017), 163- |
| | | | | 175 |
| P55/20 | S_{BET} = 502 m²/g | N/A | N/A | |
| | W_{T} = 0.26 cm³/g | | | |
| | W₀ = 0.23 cm/g | | | |
| | Wₘₑₛₒ = 0.03 cm³/g | | | |
| | D = 2.05 nm | | | |
| P50/20 | S_{BET} = 573 m²/g | N/A | N/A | |
| | W_{T} = 0.34 cm³/g | | | |
| | W₀ = 0.29 cm /g | | | |
| | Wₘₑₛₒ = 0.05 cm³/g | | | |
| | D = 2.29 nm | | | |
| P42/20 | S_{BET} = 694 m²/g | N/A | N/A | |
| | W_{T} = 0.24 cm³/g | | | |
| | W₀ = 0.42 cm³/g | | | |
| | Wₘₑₛₒ = 0.18 cm³/g | | | |
| | D = 2.33 nm | | | |
| P40/20 | S_{BET} = 764 m²/g | N/A | N/A | |
| | W₀ = 0.61 cm³/g | | | |
| | W_{T} = 0.38 cm³/g | | | |
| | Wₘₑₛₒ = 0.23 cm³/g | | | |
| | D = 3.19 nm | | | |

Characterisation of the four Pure Element samples have identified the presence of micropores in all samples, and also mesopores in P40/20. All four samples possess substantial basic surface character. Prospective applications identified for these materials according to their textural properties include CO₂ capture, soil enrichment and pharmaceutical wastewater treatment with samples P55/20 and P50/20 appearing most suitable for CO₂ capture, P42/20 and P40/20 appearing most suitable for CO₂ capture, P42/20 and P40/20 appearing most suited to pharmaceutical wastewater treatment and all four Pure Element samples according to their micro/mesoporous structure shoring potential for soil treatment.

Thus, the composition according to the invention may be used in applications including soil enrichment, pharmaceutical wastewater treatment, CO₂ capture and/or storage.

1. A composition comprising carbon and ash, wherein the composition comprises between 65 and 95% w/w carbon and between 2 and 25 w/w ash.

2. The composition according to claim 1, wherein the composition comprises between 66 and 90% w/w carbon and between 5 and 10% w/w ash.

3. The composition according to claim 1, wherein the composition further comprises between 2 and 2.5% w/w nitrogen.

4. The composition according to claim 1, wherein the composition further comprises one or more nutrients selected from the group of phosphorous, potassium, magnesium, sulphur, copper, zinc, sodium and/or calcium.

5. The composition according to claim 1, wherein the composition comprises between 80 and 90% w/w organic matter.

6. The composition according to claim 1, wherein the composition comprises between 85 and 90% w/w organic matter.

7. A method of producing a composition according to claim 1, wherein the method comprises the steps of:
loading a feedstock into a pyrolysis reactor;
heating the reactor to a temperature of between 80 and 750° C.;
carrying out a pyrolysis reaction within the reactor; and
extracting the composition from the reactor.

8. The method according to claim 7, wherein the feedstock is selected from the group consisting of pressed fruits and/or fruit pulp, vegetables, fruit stones, a by-product of whisky or beer, banana plants, coffee beans, plants, grass, leaves, herbs, olives, leaves, flowers, tea leaves and tea plants, solid digestate (waste products from an anerobic digestion process).

9. The method according to claim 8, wherein the pressed fruits and/or fruit pulp is obtained from apples, pears, grapes and/or berries.

10. The method according to claim 8, wherein the fruit stones are obtained from nectarines, peaches, apricots, avocados and/or olives.

11. The method of improving the quality of soil, compost, growing media or organic based fertiliser using a composition according to claim 1.

12. The method according to claim 11, wherein the composition is used as a soil fertility enhancer for agricultural and/or horticultural purposes.

13. The method according to claim 11, wherein composition is used as a soil fertility enhancer for vertical farming.

14. The method according to claim 11, wherein the composition is used as a soil fertility enhancer for urban greening purposes, including green roofs and walls.

15. The method according to claim 11, wherein the composition is used as an active agent to clean soils from different contaminants, wherein the contaminants may include residues from herbicides and/or pesticides.

16. The method according to claim 11, wherein the composition is used to enhance the properties of composts and similar growing media.

17. The method according to claim 11, wherein the composition is used to enhance the properties of an organic fertiliser.

18. The method of pharmaceutical wastewater treatment using a composition according to claim 1.

19. The method of carbon dioxide capture using a composition according to claim 1.

20. The method of preparing a substrate, wherein the substrate comprises a composition according to claim 1.

21. The method according to claim 20, wherein the substrate further comprises at least one of a fertiliser and/or an organic fulfilment material.

22. The method according to claim 21, wherein the fertiliser comprises worm casts and/or wherein the organic fulfilment material comprises coconut wool.

23. The method according to claim 20, wherein
the substrate is used in the treatment of fungus related diseases of the soil.

24. A substrate comprising a composition according to claim 1.

25. The substrate according to claim 24, wherein the substrate further comprises at least one of a fertiliser and/or an organic fulfilment material.

26. The substrate according to claim 25, wherein the fertiliser comprises worm casts or manure.

27. The substrate according to claim 26, wherein the organic fulfilment material comprises coconut wool.

28. The substrate according to claim 27, wherein the substrate is a living substrate.
